(19) United States
(12) Patent Application Publication
(10) Pub. No.: US 2014/0026992 A1
(43) Pub. Date: Jan. 30, 2014

(54) FUEL TANK DEPRESSURIZATION WITH SHORTENED WAIT TIME

(71) Applicants: Russell Randall Pearce, Ann Arbor, MI (US); Dennis Seung-Man Yang, Canton, MI (US); Chito M. Dancel, Rochester, MI (US)

(72) Inventors: Russell Randall Pearce, Ann Arbor, MI (US); Dennis Seung-Man Yang, Canton, MI (US); Chito M. Dancel, Rochester, MI (US)

(73) Assignee: FORD GLOBAL TECHNOLOGIES, LLC, Dearborn, MI (US)

(21) Appl. No.: 13/556,337

(22) Filed: Jul. 24, 2012

(51) Int. Cl. F03B 11/02

(52) U.S. Cl. 137/561 R; 137/14

(57) ABSTRACT

A method and apparatus for a pressurized fuel system with a fuel tank, a fuel fill pipe, and a remotely-controlled lockable fuel opening which selectably seals the pipe entrance. A carbon canister has an inlet for receiving a flow of air and fuel vapors from the tank and has an outlet providing a treated air flow to atmosphere. A fuel tank isolation valve is connected between the air space and the inlet of the carbon canister for selectively allowing pressurization of the fuel tank, wherein the pressurization must be relieved prior to refilling of fuel to the fuel tank. A vacuum pump is coupled to the outlet of the carbon canister, wherein the vacuum pump is configured to activate to increase air flow through the carbon canister from the fuel tank when the fuel tank isolation valve is opened during refilling.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to pressurized fuel systems for internal combustion vehicles, and, more specifically, to rapid depressurization of a fuel tank so that it can be opened for refueling.

Hybrid gas-electric vehicles are often designed to run using their electric components (i.e., battery and electric traction drive) as much as possible and to use the internal combustion engine only when necessary to supplement drive torque or when the remaining battery charge drops to a certain level. Thus, the gasoline-powered engine may go for long periods of use without being activated.

In current fuel systems, emissions of fuel vapors are minimized using an evaporative emission system with activated carbon placed in a carbon canister in the vent path of the fuel tank. Fuel vapors that are adsorbed from air being vented to atmosphere through the carbon canister is later drawn into the engine for combustion in order to regenerate the capacity of the carbon canister. In a hybrid vehicle, however, the infrequent use of the internal combustion engine results in fewer opportunities to purge the carbon canister. Therefore, the fuel tank is often sealed so that the vapor is stored in the fuel tank.

When a user of a hybrid vehicle desires to refuel (i.e., add fuel to the fuel tank), a potentially unsafe condition would exist if the tank was unsealed while containing a high vapor pressure. Liquid and gaseous fuel could be expelled from the fuel filler opening. Consequently, remotely-controlled locking doors/caps have been employed to prevent the fuel system from being opened until the fuel tank can be sufficiently vented to reduce the pressure. A normally-closed fuel tank isolation valve is typically used to selectably couple the air space in the fuel tank to either the carbon canister (for cleaning when venting to atmosphere) or the engine intake (during a purge operation). In order to open the fuel tank for refueling, the isolation valve is opened so that the fuel tank is vented to atmosphere through the carbon canister. The fuel filler door remains locked until the tank pressure is reduced to a predetermined threshold.

In non-integrated evaporative emissions systems, the driver presses a refueling request button when arriving at a fuel pump in order to begin the depressurization of the fuel tank. Depending on several factors including the size of the air space in the tank, the fuel level in the tank, the ambient temperature of the fuel tank, and the size of the carbon canister, there will be a variable length delay to depressurize as an air flow from the fuel tank through the carbon canister is driven by the existing pressure differential. A typical delay target for opening the fuel filler door after a request is about 5 to 10 seconds. Under certain conditions such as high ambient temperatures, however, delays of as much as twenty minutes have been experienced in non-integrated evaporative emissions systems.

### SUMMARY OF THE INVENTION

In one aspect of the invention, a method is provided for opening a pressurized fuel system for refilling a fuel tank via a fuel fill pipe. The fuel fill pipe is covered by a remotely-controlled lockable fuel opening. The fuel tank has an air space coupled by a fuel tank isolation valve to an inlet of a carbon canister for treating an air flow to remove fuel vapors. The carbon canister has an outlet coupled to atmosphere. The method comprises receiving a request for opening the fuel system when the fuel opening is locked. The fuel tank isolation valve is opened while the fuel opening remains locked. A high tank pressure condition is detected in which opening the fuel fill pipe is potentially unsafe. If the high pressure condition is detected, then a vacuum assist pump coupled between the carbon canister outlet and atmosphere is activated to increase a flow of treated air through the carbon canister. The fuel tank pressure is measured, and the vacuum assist pump is deactivated when the measured tank pressure decreases to a predetermined pressure. Then the fuel opening is unlocked.

### BRIEF DESCRIPTION OF THE DRAWINGS

FIG. 1 is a block diagram showing a fuel system of a type to which the invention relates. FIG. 2 is a flowchart showing a prior art method for depressurizing a fuel tank prior to refilling.

FIG. 3 is a block diagram showing a pressurized fuel system of the present invention in greater detail.

FIG. 4 is a flowchart showing a first embodiment of the invention.

FIG. 5 is a flowchart showing one embodiment for a method of detecting a high pressure condition in a fuel tank prior to refilling.

### DETAILED DESCRIPTION OF PREFERRED EMBODIMENTS

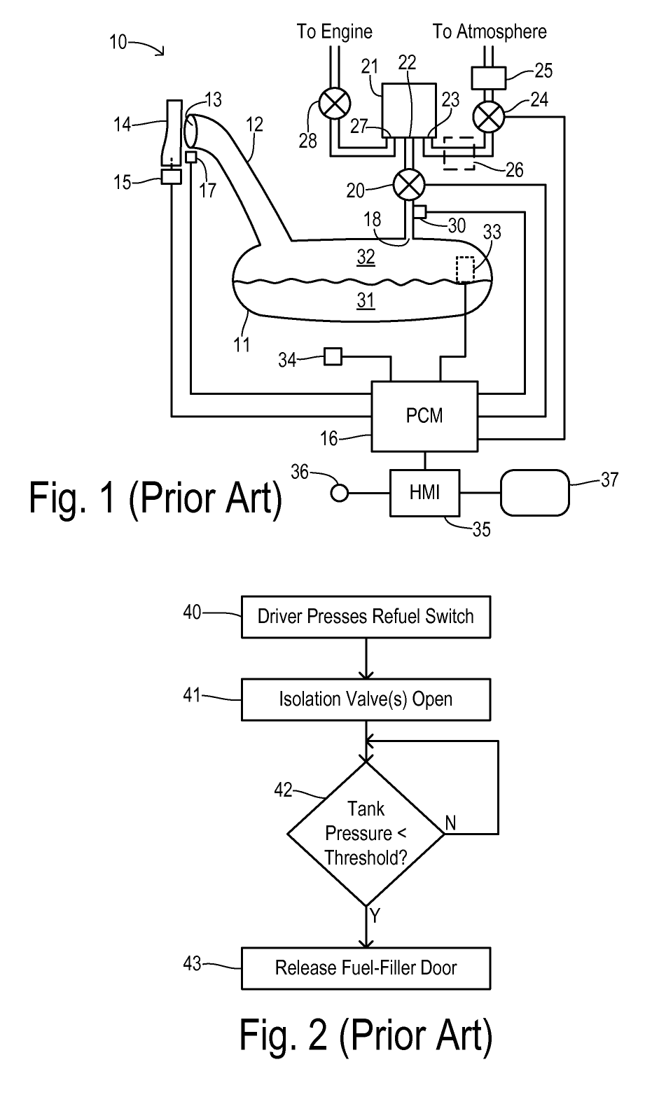

Referring to FIG. 1, a non-integrated refueling canister only system (NIRCOS) 10 is shown having a closed fuel tank 11. A fuel filler pipe 12 couples tank 11 to a refuel opening 13, which is covered by a remotely controlled fuel filler door 14. A solenoid or locking motor 15 is incorporated with fuel door 14 and is controlled according to a lock control signal from a controller 16. A fuel door ajar sensor 17 may also be connected to controller 16 so that proper sealing of the fuel system can be confirmed by controller 16. Controller 16 may be implemented as part of a powertrain control module (PCM), for example.

Fuel tank 11 has a vapor outlet 18 which is coupled by a fuel tank isolation valve (FTIV) 20 to an inlet 22 of a carbon canister 21. A fresh air outlet 23 of carbon canister 21 is coupled to atmosphere via a vent valve 24 and an air filter/spider trap 25. FTIV 20 and vent valve 24 assume an open or closed state in response to controller 16 in a conventional manner. An onboard diagnostic (OBD) module 26 may be incorporated in the airflow path from carbon canister 21 to atmosphere. Module 26 preferably includes a vacuum pump which is used conventionally for drawing a vacuum to perform standard OBD leak testing of FTIV 20 at designated times not associated with refueling.

Carbon canister 21 has a second outlet 27 coupled to an intake of an internal combustion engine (not shown) via a purge valve 28 which is also controlled by PCM controller 16 in order to purge accumulated fuel vapors from carbon canister 21 into the engine for burning.

A fuel tank pressure transducer 30 provides a measured fuel tank pressure to controller 16. Fuel tank 11 includes liquid fuel 31 and has an air space 32 above the fuel where fuel vapor accumulates with the air. The liquid fuel level is sensed by a fuel level sensor 33 which provides a corresponding signal to controller 16. An ambient temperature sensor 34 provides a temperature signal to controller 16 which reflects the temperature of fuel 31 which has a relationship to the vapor pressure within airspace 32.

The vehicle includes a human machine interface (HMI) 35 which includes a dashboard-mounted request switch 36 which can be manually activated by the driver to signal their desire to open the fuel system for refueling. A message center 37 is also connected to HMI 35 for displaying messages to the driver to indicate any necessary waiting period before the fuel filler door is opened or openable.

A conventional method for depressurizing the fuel tank for refueling is shown in FIG. 2. In step 40, the driver presses the refueling request switch. In response, the controller opens the appropriate fuel tank isolation valves (e.g., FTIV 20 and vent valve 24 in FIG. 1) to allow pressurized air and fuel vapors within the air space of the fuel tank to pass through the carbon canister, so that the airflow being vented to atmosphere is treated to remove fuel vapor emissions within the carbon canister. The controller monitors tank pressure in step 42. If the tank pressure has not reduced to a level less than a predetermined threshold, then the controller continues to wait in step 42. Once the tank pressure is below the predetermined threshold, the fuel filler door is released/opened in step 43. The message center preferably displays a message saying “please wait” during the execution of steps 41 and 42, and then displays a message stating “okay to refuel” in step 43.

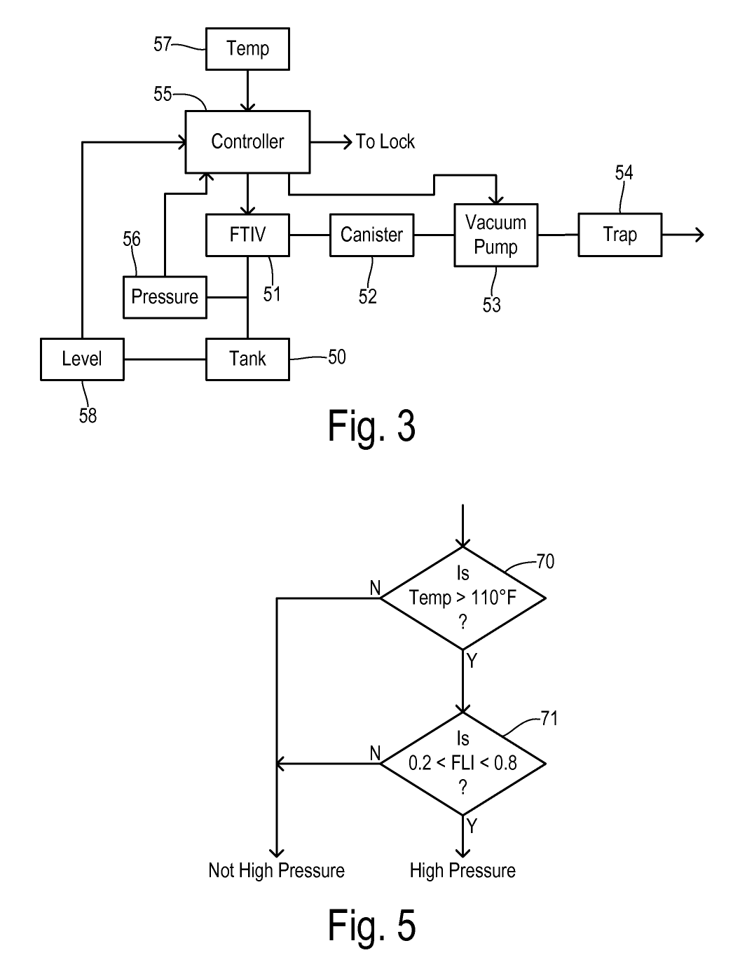

With the system of FIG. 1 and the method in FIG. 2, the pressure differential between the fuel tank and the external atmosphere drives the airflow. At very tank high pressures, the amount of fuel vapor needing to be adsorbed in the carbon canister can result in significant wait times until the tank pressure is sufficiently reduced to enable safe opening of the fuel filler door. The present invention reduces the delay by using a vacuum pump to supplement airflow through the canister during depressurization as shown in FIG. 3. An airflow path from tank 50 includes an FTIV 51, carbon canister 52, vacuum pump 53, and air filter/trap 54 when depressurizing tank 50 to atmosphere. A controller 55 receives a pressure signal from pressure transducer 56, an ambient temperature signal from temperature sensor 57, and a fuel level signal from level sensor 58 in order to determine when to unlock the fuel filler door and when to activate vacuum pump 53 as described below.

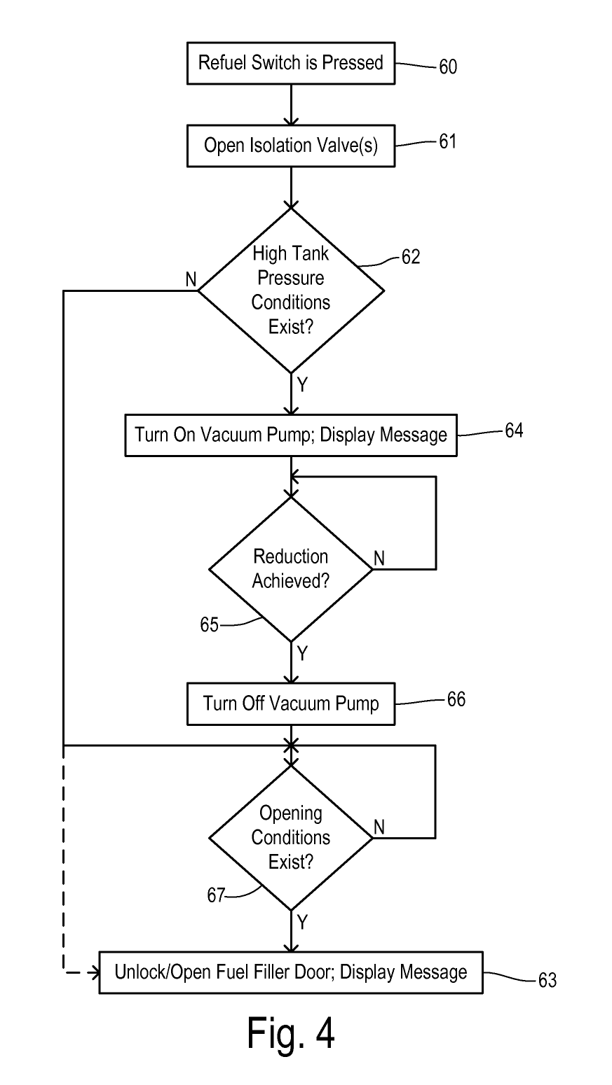

One preferred method of the invention is shown in FIG. 4 wherein the refuel request switch is pressed in step 60. In step 61, the FTIV valve and a vent valve (if present) are opened to provide the necessary airflow path from the fuel tank to atmosphere. A check is made in step 62 to determine whether a high tank pressure condition exists. If a high tank pressure condition does not exist, then the method jumps to step 63 wherein the fuel filler door is unlocked and an “okay to refuel” message is displayed.

If a high tank pressure condition does exist, then the vacuum is turned on in step 64 and a message is displayed to the driver to wait for refueling. The tank pressure is monitored in step 65 and a check is made to determine whether the desired reduction in tank pressure has been achieved. If not, then the method re-executes step 65. Once the reduction has been achieved, the vacuum pump is turned off at step 66. A typical threshold pressure (i.e., target) to be achieved in the fuel tank for safely opening the fuel door may be about 10″ H₂O, for example.

After turning off the vacuum pump in step 66, the fuel filler door may be opened (i.e., is unlocked) in step 63 and an appropriate okay message is displayed to the driver. An optional step that may be performed between steps 66 and 63 or between 62 and 63 involves a check for other potential opening conditions that may be desirable for restricting opening of the fuel tank. For instance, the vacuum pump may be turned off at one particular pressure threshold and the fuel door opened after further venting to a lower threshold of pressure. In another example, the further opening condition may be comprised of a predetermined delay that follows the deactivation of the vacuum pump to ensure that the tank pressure settles to a constant value (e.g., in case of any pressure rebound associated with the deactivation of the vacuum pump).

In one preferred embodiment, the high tank pressure conditions monitored by step 62 may be comprised of a direct measurement of the tank pressure for comparing it with a predetermined threshold pressure. The predetermined threshold corresponds to a known pressure that correlates with possible unsafe escape of fuel or vapors through the fill pipe (e.g., about 10″ H₂O). Alternatively, the high tank pressure conditions may instead be evaluated based on other factors such as ambient temperature and fuel tank level as shown in FIG. 5. In this embodiment, step 62 of

FIG. 4 is comprised of the checks shown in steps 70 and 71. In step 70, the ambient temperature is compared to a predetermined temperature (such as 110° F.). If the temperature is below the predetermined temperature, then a high tank pressure condition is not detected. If the ambient temperature is greater than 110° F., then a check is performed in step 71 to determine whether the fuel level indicator (FLI) signal from the level sensor is in a predetermined range of levels (e.g., between 20% and 80% of fuel tank capacity). If not in the range, then the high tank pressure condition is not detected. If within the range, then the high tank pressure condition is detected. The ambient temperature and fuel level conditions that correspond to a high pressure state requiring that depressurization be supplemented using the vacuum pump may be empirically determined based on the design of each particular fuel system.

The foregoing invention has demonstrated a method and apparatus for reducing the time to depressurize a fuel tank in order to refuel a closed fuel tank system. Depressurization that would conventionally take 20 minutes or more can be achieved within 15 seconds from the time the driver indicates a desire to refuel. By employing a vacuum pump that may already be incorporated in a fuel system for purposes of leak testing of the fuel tank isolation valve, the invention can be implemented with low cost.

What is claimed is:

1. A method for opening a pressurized fuel system for refilling a fuel tank via a fuel fill pipe, wherein the fuel fill pipe is covered by a remotely-controlled lockable fuel opening, wherein the fuel tank has an air space coupled by a fuel tank isolation valve to an inlet of a carbon canister for treating an air flow to remove fuel vapors, and wherein the carbon canister has an outlet coupled to atmosphere, the method comprising the steps of:
receiving a request for opening the fuel system when the fuel opening is locked;
opening the fuel tank isolation valve while the fuel opening remains locked;
detecting a high tank pressure condition in which opening the fuel fill pipe is potentially unsafe;
if the high pressure condition is detected, then activating a vacuum assist pump coupled between the carbon canister outlet and atmosphere to increase a flow of treated air through the carbon canister;
measuring fuel tank pressure;
deactivating the vacuum assist pump when the measured tank pressure decreases to a predetermined pressure; and
unlocking the fuel opening.

2. The method of claim 1 wherein the step of detecting a high tank pressure condition is comprised of:
measuring an ambient temperature;
measuring a fuel level within the fuel tank;
comparing the ambient temperature to a predetermined temperature; and
comparing the fuel level with a predetermined range of levels;
wherein the high tank pressure condition is detected when the ambient temperature is greater than the predetermined temperature and the fuel level is within the predetermined range.

3. The method of claim 1 wherein the step of detecting a high tank pressure condition is comprised of:
measuring fuel tank pressure; and
comparing the measured fuel tank pressure to a threshold pressure;
wherein the high tank pressure condition is detected when the measured pressure is greater than the threshold pressure.

4. The method of claim 3 wherein the threshold pressure is equal to the predetermined pressure.

5. A pressurized fuel system for a vehicle with an internal combustion engine, comprising:
a fuel tank for holding fuel, the fuel tank providing an air space above the fuel;
a fuel fill pipe for conveying fuel from a pipe entrance to the fuel tank during filling;
a remotely-controlled lockable fuel opening which selectably seals the pipe entrance;
a carbon canister having an inlet for receiving a flow of air and fuel vapors from the air space and having an outlet providing a treated air flow to atmosphere;
a fuel tank isolation valve connected between the air space and the inlet of the carbon canister for selectively isolating the fuel tank from the carbon canister to allow pressurization of the fuel tank, wherein the pressurization must be relieved prior to refilling of fuel to the fuel tank; and
a vacuum pump coupled to the outlet of the carbon canister, wherein the vacuum pump is configured to activate to increase air flow through the carbon canister from the fuel tank when the fuel tank isolation valve is opened during refilling.

6. The system of claim 5 wherein the vacuum pump is further configured to perform tests of the fuel tank isolation valve when the fuel tank is not being refilled.

7. The system of claim 5 further comprising:
a controller for receiving a request for opening the fuel system at a time when the fuel opening is locked, opening the fuel tank isolation valve while the fuel opening remains locked, detecting a high tank pressure condition in which opening the fuel fill pipe is potentially unsafe, if the high pressure condition is detected then activating the vacuum assist pump, deactivating the vacuum assist pump when tank pressure decreases to a predetermined pressure, and unlocking the fuel opening.

8. The system of claim 7 further comprising:
a temperature sensor measuring an ambient temperature; and
a level sensor measuring a fuel level within the fuel tank;
wherein the controller compares the ambient temperature to a predetermined temperature and compares the fuel level with a predetermined range of levels, and wherein the high tank pressure condition is detected when the ambient temperature is greater than the predetermined temperature and the fuel level is within the predetermined range.

9. The system of claim 7 further comprising:
a pressure sensor measuring fuel tank pressure;
wherein the controller compares the measured fuel tank pressure to a threshold pressure, and wherein the high tank pressure condition is detected when the measured pressure is greater than the threshold pressure.

10. The system of claim 9 wherein the threshold pressure is equal to the predetermined pressure.
